(19) United States
(12) Patent Application Publication
(10) Pub. No.: US 2015/0086889 A1
(43) Pub. Date: Mar. 26, 2015

(54) METHOD FOR RECOVERING PERFORMANCE OF FUEL-CELL STACK

(71) Applicant: Hyundai Motor Company, Seoul (KR)

(72) Inventors: Dong Jo Oh, Yongin (KR); Seung Ki Yang, Yongin (KR); Young Min Kim, Gangneung (KR); Yei Sik Jeon, Seoul (KR); Jong Hyun Lee, Yongin (KR)

(73) Assignee: Hyundai Motor Company, Seoul (KR)

(21) Appl. No.: 14/140,931

(22) Filed: Dec. 26, 2013

(30) Foreign Application Priority Data
Sep. 25, 2013 (KR) 10-2013-0113593

(51) Int. Cl. H01M 8/04; H01M 8/24

(52) U.S. Cl. CPC H01M 8/04753; H01M 8/04104; H01M 8/04201; H01M 8/04768; H01M 8/24
USPC 429/427

(57) ABSTRACT

A method for recovering performance of a fuel-cell stack is provided. When hydrogen used as fuel of the fuel-cell stack is contaminated, air is supplied to an anode instead of hydrogen to remove impurities and recover the performance of the fuel-cell stack. The method includes supplying air to an anode of the fuel-cell stack in an operation stop state of the fuel-cell stack to decrease a stack voltage.

### CROSS-REFERENCE TO RELATED APPLICATION

This application claims under 35 U.S.C. §119(a) the benefit of Korean Patent Application No. 10-2013-0113593 filed on Sep. 25, 2013, the entire contents of which are incorporated herein by reference.

### BACKGROUND

(a) Technical Field

The present disclosure relates to a method for recovering performance of a fuel-cell stack, and more particularly, to a method for recovering performance of a fuel-cell stack to recover the performance of the fuel-cell stack without removal of the fuel-cell stack from a vehicle in case of contamination of hydrogen used as fuel of the fuel-cell stack.

(b) Background Art

Generally, a fuel-cell stack undergoes sharp performance degradation when hydrogen used as fuel includes impurities. Accordingly, impurities in hydrogen should be managed and when the performance of the stack degrades due to the impurities in hydrogen, the performance should be recovered. Conventionally, when the stack performance degradation is caused by the hydrogen impurities, a performance recovery operation is performed in which the stack is first removed from the vehicle for supply of high-temperature hydrogen to an air electrode (or a cathode), and then an air blower that supplies air to the cathode is stopped and hydrogen purged (or discharged) from a fuel electrode (or an anode) to the exterior of the stack is supplied to the cathode to decrease a stack voltage to a target voltage using (or executing) a Cathode Oxygen Depletion (COD) function. However, substantial cost and time are incurred during the performance recovery operation, causing inconvenience to customers and degrading vehicle salability.

### SUMMARY

Accordingly, various aspects of the present invention provide a method for recovering performance of a fuel-cell stack in which when hydrogen used as fuel of the fuel-cell stack is contaminated, air is supplied to an anode instead of hydrogen to remove impurities and recover the performance of the fuel-cell stack.

According to one of various aspects of the present invention, a method for recovering performance of a fuel-cell stack may include supplying air to an anode of the fuel-cell stack in an operation stop state of the fuel-cell stack to decrease a stack voltage. Air discharged from the fuel-cell stack or air supplied to the fuel-cell stack may be supplied to a hydrogen purge line connected to the anode. Air supplied to an air discharge line or an air supply line of the fuel-cell stack may be supplied to a hydrogen purge line connected to the anode. An air-hydrogen connection line that connects an air discharge line of the fuel-cell stack and a hydrogen purge line may be open to allow the air of the air discharge line flow into the anode. In addition, an air-hydrogen connection line that connects an air supply line of the fuel-cell stack and a hydrogen purge line may be open to allow the air of the air supply line flow into the anode. Before the air is supplied to the anode, a coolant may be supplied to the fuel-cell stack to cool the fuel-cell stack. An air supply device for increasing pressure of the air discharge line may be actuated.

When a voltage of the fuel-cell stack reaches a target voltage, the air-hydrogen connection line that connects the air discharge line of the fuel-cell stack and the hydrogen purge line may be cut off. In addition, when a voltage of the fuel-cell stack reaches a target voltage, the air-hydrogen connection line that connects the air supply line of the fuel-cell stack and the hydrogen purge line may be cut off. When a voltage of the fuel-cell stack reaches a target voltage, the air supply device may be stopped. When a temperature of the fuel-cell stack decreases to an exterior air temperature supply of the coolant may be stopped. An air cutoff valve of the air discharge line may be closed to facilitate increase in a pressure of the air discharge line. Further, an air cutoff valve of the air supply line may be closed to facilitate increase in a pressure of the air supply line.

According to another aspect of the present invention, a method for recovering performance of a fuel-cell stack may include during an operation stop state of the fuel-cell stack, opening an air-hydrogen connection line that connects an air discharge line of the fuel-cell stack and a hydrogen purge line to allow air discharged from a cathode of the fuel-cell stack to flow into an anode.

According to another aspect of the present invention, a method for recovering performance of a fuel-cell stack may include during an operation stop state of the fuel-cell stack, opening an air-hydrogen connection line that connects an air supply line of the fuel-cell stack and a hydrogen purge line to allow air supplied to a cathode of the fuel-cell stack to flow into an anode.

### BRIEF DESCRIPTION OF THE DRAWINGS

The above and other features of the present invention will now be described in detail with reference to exemplary embodiments thereof illustrated the accompanying drawings which are given herein below by way of illustration only, and thus are not limitative of the present invention, and wherein:

FIG. 1 is an exemplary diagram for describing a method for recovering performance of a fuel-cell stack according to an exemplary embodiment of the present invention;

FIG. 2A is an exemplary diagram schematically showing a fuel cell system for performing a process of recovering performance of a fuel-cell stack according to an exemplary embodiment of the present invention;

FIG. 2B is an exemplary diagram schematically showing a fuel cell system for performing a process of recovering performance of a fuel-cell stack according to another exemplary embodiment of the present invention;

FIG. 3 is an exemplary diagram for describing a method for recovering performance of a fuel-cell stack according to an exemplary embodiment of the present invention; and

FIG. 4 is an exemplary diagram showing test results for verifying a method for recovering performance of a fuel-cell stack according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described to allow those of ordinary skill in the art to easily carry out the present invention.

The present invention relates to a method for recovering performance of a fuel-cell stack by removing impurities in hydrogen when the hydrogen used as fuel of the fuel-cell stack is contaminated, in which when a vehicle is stopped due to performance degradation of the fuel-cell stack, air may be supplied from a cathode to an anode to decrease a stack voltage to a target voltage and then the vehicle may be restarted. In other words, in the present invention, by using an existing fuel cell system without any configuration change therein, air may be supplied to an anode instead of hydrogen, to recover stack performance. Additionally, in the present invention, unlike conventional techniques for supplying hydrogen to the cathode, air may be supplied to the anode in an operation stop state of the fuel-cell stack to recover the stack performance, to perform a recovery operation without removal of the stack from the vehicle.

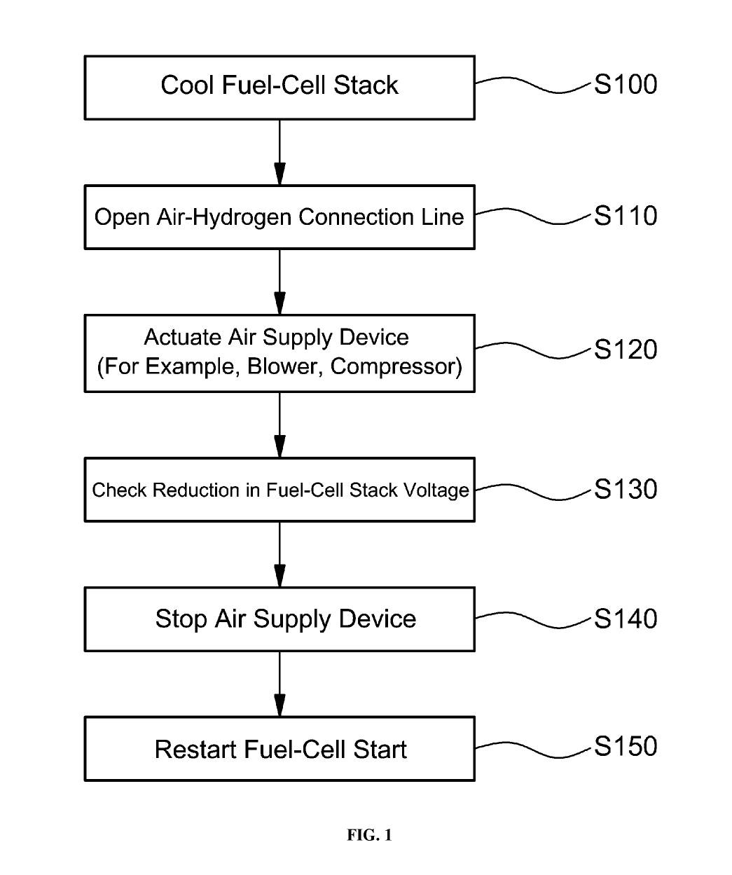

As shown in FIG. 1, the method for performance of a fuel-cell stack according to an exemplary embodiment of the present invention may include cooling the fuel-cell stack S100, opening an air-hydrogen connection line S110, operating an air supply device S120, monitoring a voltage of the fuel-cell stack S130, stopping the air supply device based on the voltage of the fuel-cell stack S140, and re-starting the fuel-cell stack S150.

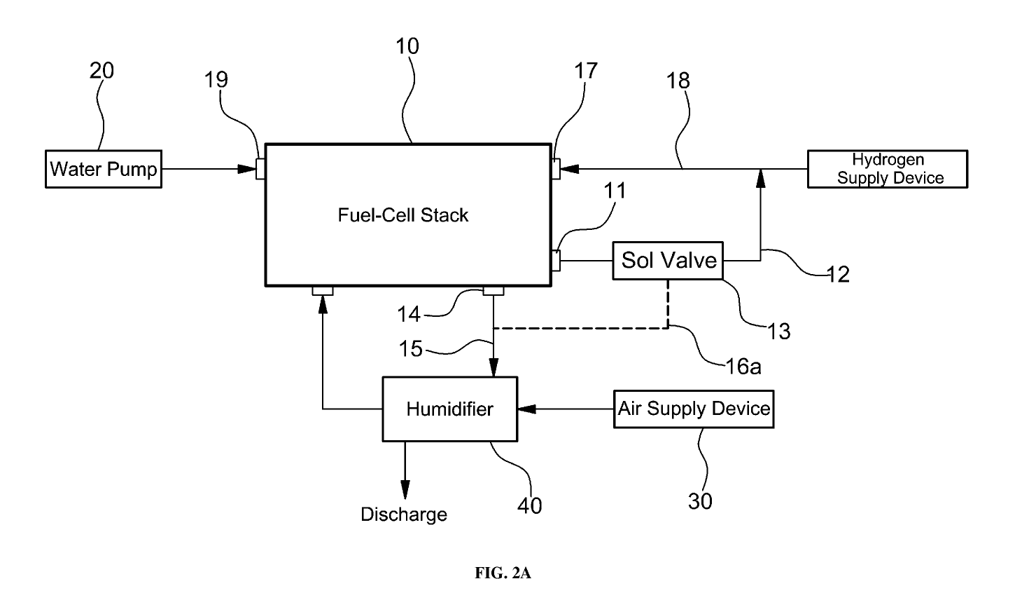

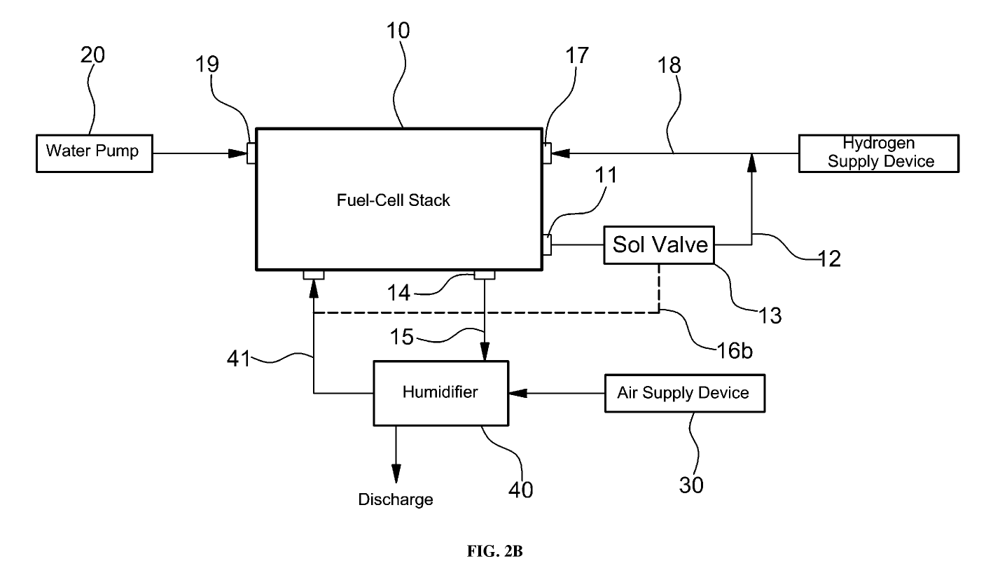

FIG. 2A is an exemplary diagram schematically showing a fuel cell system for performing the performance recovery operation of the fuel-cell stack 10 according to an exemplary embodiment of the present invention. When stack performance deteriorates due to contamination of hydrogen, driving of the fuel-cell stack 10 may be stopped and a coolant may be supplied to the stack 10 to decrease the stack temperature to an exterior air temperature.

When air is supplied to the anode, deterioration may occur due to formation of an interface within the anode. Thus, the stack 10 may be cooled using the coolant prior to supply of air to minimize degradation caused by formation of the interface in the anode, thus removing negative effects caused by air. In particular, the coolant may be forcedly cooled using a water pump 20 and a radiator, and the coolant cooled by the radiator may be supplied to the stack 10 via the water pump 20 to decrease the stack temperature (e.g., a temperature at a coolant inlet of the stack 10). Thereafter, a hydrogen purge valve 13 connected to a hydrogen outlet 11 of the stack 10 may be opened to open an air-hydrogen connection line 16a.

As shown in FIG. 2A, the air-hydrogen connection line 16a may be a line having a flow path formed to enable supply and movement of air between the air outlet 14 of the stack 10 and the hydrogen purge valve 13. In other words, the air-hydrogen connection line 16a may be formed to enable movement of air between a hydrogen purge line 12 and an air discharge line 15, to supply air discharged from the air outlet 14 (or the cathode) or air from the air discharge line 15 to the hydrogen purge line 12 as the hydrogen purge valve 13 is opened.

To efficiently supply air to the hydrogen purge line 12 when the hydrogen purge valve 13 is opened, an air supply device 30 may be actuated. The air supply device 30 may be configured to supply the exterior air to a humidifier 40 connected to the air discharge line 15. As the air supply device 30 is actuated, the pressure of the air discharge line 15 may increase, and thus the moving speed of the air supplied from the air discharge line 15 to the hydrogen purge line 12 may increase. In particular, the air supply device 30 may be an air blower or a compressor.

The air supplied to the hydrogen purge line 12 through the hydrogen purge valve 13 may flow into the anode via the hydrogen outlet 11 or may flow into the anode via a hydrogen inlet 17 along a fuel supply line 18. In particular, the air discharge line 15 may have a flow path that connects the air outlet 14 of the stack 10 with the humidifier 40, and the hydrogen purge line 12 may have a flow path extraneous to the stack connected to the hydrogen outlet 11, and the fuel supply line 18 may have a flow path that connects the hydrogen inlet 17 of the stack 10 with a hydrogen supply device.

FIG. 2B is an exemplary diagram schematically showing a fuel cell system for performing a process of recovering performance of the fuel-cell stack 10 according to another exemplary embodiment of the present invention. As shown in FIG. 2B, an air-hydrogen connection line 16b may be a line having a flow path formed to enable supply and movement of air between an air inlet 42 of the stack 10 and the hydrogen purge valve 13. The air-hydrogen connection line 16b may be a line formed to enable movement of air between the hydrogen purge line 12 and an air supply line 41. As the hydrogen purge valve 13 is opened, air supplied to the air inlet 42 (or air in the air supply line 41) may be supplied to the hydrogen purge line 12. Further, as the air supply device 30 is actuated, air may be supplied to the hydrogen purge line 12 through the air-hydrogen connection line 16b. In particular, the air supply line 41 may have a flow path that connects the air inlet 42 with the humidifier 40.

During injection of air to the anode of the stack 10, the voltage of the stack 10 may be monitored and when the stack voltage is reduced to the target voltage or less, the air supply device 30 may stop and the hydrogen purge valve 13 may be closed to cut off the air-hydrogen connection line 16a or 16b and then the stack 10 may be restarted. In other words, a time (or moment) for supplying air to the anode (or for operating the air supply device 30) may be determined by monitoring the stack voltage, and until the stack voltage reaches the target voltage, the air supply device 30 may be operated to supply air to the anode. Once the stack voltage reaches the target voltage, the stack 10 may be restarted to complete the performance recovery operation.

Hereinafter, the exemplary embodiment of the present invention will be described in more detail, but the present invention is not limited to the description.

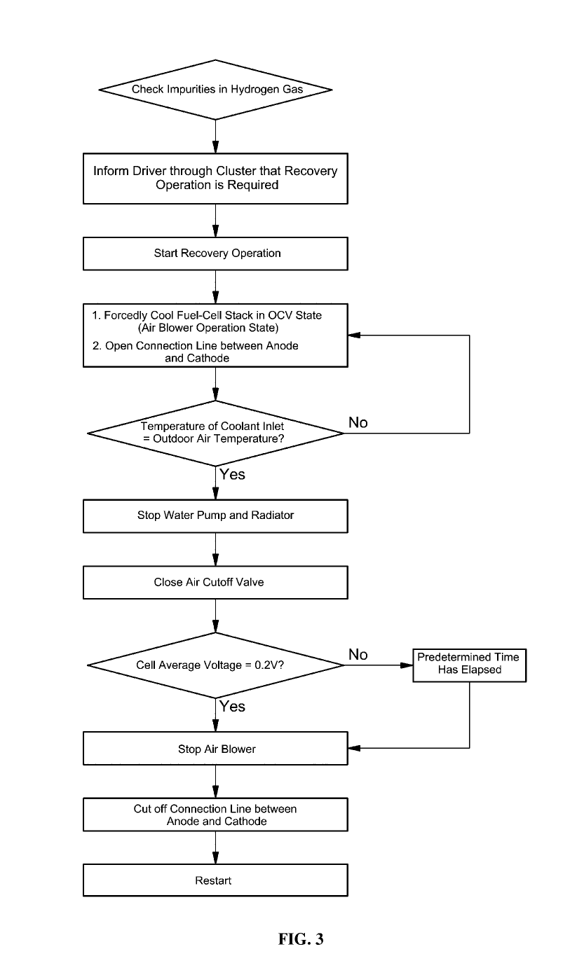

As shown in FIG. 3, when impurities in hydrogen gas of the stack are sensed or confirmed, a driver may be informed via a cluster of a vehicle that the performance recovery operation of the stack is required. Additionally, to detect the impurities in the hydrogen gas, the impurities in hydrogen may be sensed using an impurity sensor, or sharp performance degradation of the stack may be sensed using a voltage measurement sensor after charge of hydrogen in the stack. After parking the vehicle according to a notification of the cluster, a driver may perform control for stack performance recovery.

Furthermore, to prevent stack deterioration, the stack 10 may be forcedly cooled in an Open Circuit Voltage (OCV) state. When the air blower is actuated, the coolant may be injected into the stack 10. The hydrogen purge valve 13 may be opened to open the air-hydrogen connection line 16a between the air discharge line 15 and the hydrogen purge line 12. Alternatively, the hydrogen purge value 13 may be opened to open the air-hydrogen connection line 16b between the air supply line 41 and the hydrogen purge line 12.

Thereafter, the temperature of a coolant inlet 19 of the stack 10 may be measured and when the temperature of the coolant inlet 19 is reduced to about the exterior air temperature, then the water pump 20 and the radiator may be stopped. When the temperature of the coolant inlet 19 is greater than the exterior air temperature, the air blower 30 may be configured to supply air to the anode until the temperature of the coolant inlet 19 is decreased to the exterior air temperature. After the water pump 20 and the radiator are stopped, an air cutoff valve connected to the air outlet 14 (or the air inlet 41) may be closed.

When the air cutoff valve is closed, pressure increase of the air discharge line 15 and the air-hydrogen connection line 16a (or the air supply line 41 and the air-hydrogen connection line 16b) may be facilitated, and air supply to the hydrogen purge line 12 may be performed smoothly. As the air is supplied to the anode of the stack 10, the stack voltage may be monitored to detect an average stack cell voltage. When the average stack cell voltage decreases to about 0.2V, the air blower 30 may be stopped and the air-hydrogen connection line 16a or 16b may be cut off to stop air supply to the anode. When the stack cell average voltage does not reach the target voltage even after an elapse of a predetermined time from driving of the air blower 30, the air blower 30 may be forcedly stopped regardless of the stack cell average voltage and then the stack 10 may be restarted.

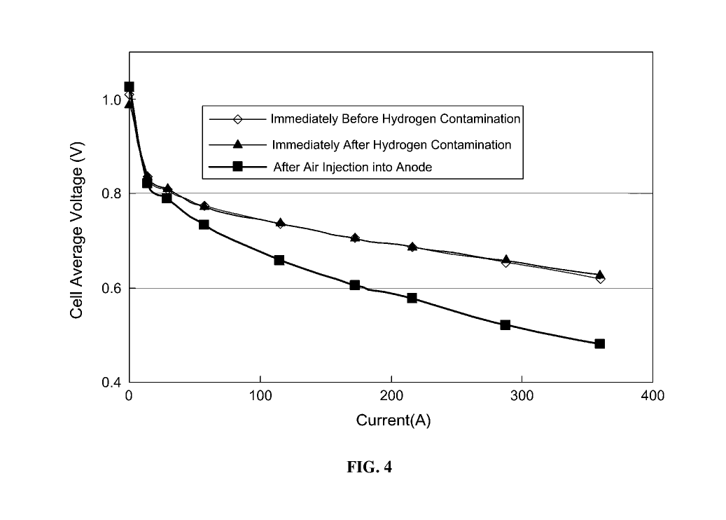

Moreover, to verify the method for recovering performance of the fuel-cell stack according to an exemplary embodiment of the present invention, stack cell average voltages measured before and after contamination of hydrogen in the anode and a stack cell average voltage measured after injection of the air into the anode were compared. As a result, as shown in FIG. 4, when compared to the stack cell average voltage measured before contamination of hydrogen, the stack cell average voltage measured after contamination of hydrogen indicates sharp degradation in the stack performance (e.g., voltage). Further, after injection of the air into the anode and performing of the performance recovery operation, the stack performance may be recovered to the about same level as before contamination of hydrogen. In other words, the test result of the applicability of the present invention on the fuel cell system shows that performance degradation caused by hydrogen impurities may be recovered.

As is apparent from the foregoing description, the method for recovering the performance of the fuel-cell stack according to an exemplary embodiment of the present invention, unlike conventional techniques, may supply air to the anode instead of hydrogen, to recover stack performance without removal of the fuel-cell stack from the vehicle. Moreover, the present invention may recover stack performance at lower cost by using the existing fuel cell system without configuration change in the fuel cell system, and thus the salability and customer satisfaction of fuel cell vehicles may be improved.

While the exemplary embodiment of the present invention have been described in detail, the scope of the present invention is not limited to the foregoing embodiment and various modifications and improves made by those of ordinary skill in the art using the basic concept of the present invention defined in the accompanying claims are also included in the scope of the present invention.

Description of Reference Numerals

| | |
|---|---|
| 10: Fuel-cell stack | 11: Hydrogen Outlet |
| 12: Hydrogen Purge Line | 13: Hydrogen Purge Valve |
| 14: Air Outlet | 15: Air Discharge Line |
| 16a, 16b: Air-Hydrogen Connection line | 17: Hydrogen Het |
| 18: Fuel Supply Line | 19: Coolant Inlet |
| 20: Water Pump | 30: Air Supply Device |
| 40: Humidifier | 41: Air Supply Line |
| 42: Air Inlet | |

What is claimed is:

1. A method for recovering performance of a fuel-cell stack, comprising:
supplying air to an anode of the fuel-cell stack in an operation stop state of the fuel-cell stack to reduce a stack voltage.

2. The method of claim 1, further comprising:
supplying air discharged from the fuel-cell stack or air supplied to the fuel-cell stack to a hydrogen purge line connected to the anode.

3. The method of claim 1, further comprising:
supplying air supplied to an air discharge line or an air supply line of the fuel-cell stack to a hydrogen purge line connected to the anode.

4. The method of claim 1, further comprising:
opening an air-hydrogen connection line that connects an air discharge line of the fuel-cell stack and a hydrogen purge line to allow the air of the air discharge line to flow into the anode.

5. The method of claim 1, further comprising:
opening an air-hydrogen connection line that connects an air supply line of the fuel-cell stack and a hydrogen purge line to allow the air of the air supply line to flow into the anode.

6. The method of claim 5, wherein before the air is supplied to the anode, a coolant is supplied to the fuel-cell stack to cool the fuel-cell stack.

7. The method of claim 4, further comprising:
actuating an air supply device to increase pressure of the air discharge line.

8. The method of claim 4, further comprising:
cutting off the air-hydrogen connection line that connects the air discharge line of the fuel-cell stack and the hydrogen purge line when the voltage of the fuel-cell stack reaches a target voltage.

9. The method of claim 5, further comprising:
cutting off the air-hydrogen connection line that connects the air supply line of the fuel-cell stack and the hydrogen purge line when the voltage of the fuel-cell stack reaches a target voltage.

10. The method of claim 7, further comprising:
stopping operation of the air supply device when the voltage of the fuel-cell stack reaches a target voltage.

11. The method of claim 6, further comprising:
stopping supply of the coolant when a temperature of the fuel-cell stack decreases to an exterior air temperature.

12. The method of claim 4, further comprising:
closing an air cutoff valve of the air discharge line to facilitate increase in a pressure of the air discharge line.

13. The method of claim 5, further comprising:
closing an air cutoff valve of the air supply line to facilitate increase in a pressure of the air supply line.

14. A method for recovering performance of a fuel-cell stack, comprising:
opening an air-hydrogen connection line that connects an air discharge line of the fuel-cell stack and a hydrogen purge line in an operation stop state of the fuel-cell stack, to allow air discharged from a cathode of the fuel-cell stack to flow into an anode.

15. A method for recovering performance of a fuel-cell stack, comprising:
opening an air-hydrogen connection line that connects an air supply line of the fuel-cell stack and a hydrogen purge line in an operation stop state of the fuel-cell stack, to allow air supplied to a cathode of the fuel-cell stack to flow into an anode.
